(19) United States
(12) Patent Application Publication
(10) Pub. No.: US 2007/0155339 A1
(43) Pub. Date: Jul. 5, 2007

(54) Method and apparatus for initialization of integrity protection

(75) Inventor: Sam Shiaw-Shiang Jiang, Taipei City (TW)

Correspondence Address: BIRCH, STEWART, KOLASCH & BIRCH, LLP, 8110 GATEHOUSE ROAD, SUITE 100 EAST, FALLS CHURCH, VA, 22315, US

(73) Assignee: Innovative Sonic Limited

(21) Appl. No.: 11/649,239

(22) Filed: Jan. 4, 2007

Related U.S. Application Data
(60) Provisional application No. 60/766,246, filed on Jan. 4, 2006.

(51) Int. Cl. H04B 1/38

(52) U.S. Cl. 455/73

(57) ABSTRACT

A method of starting Integrity Protection in a receiving end of a radio communications system starts with receiving a first Radio Resource Control (RRC) message for starting Integrity Protection. Then, a first Signaling Radio Bearer (SRB) is used to output a second RRC message to a network end of the radio communications system for indicating completion of starting Integrity Protection. Finally, a second SRB is prohibited from transmitting a third RRC message before receiving a confirmation message from the network end acknowledging successful receipt of the second RRC message.

### CROSS REFERENCE TO RELATED APPLICATIONS

This application claims the benefit of U.S. Provisional Application No. 60/766,246, filed on Jan. 4, 2006 and entitled “Method and Apparatus for Initialization of Integrity Protection,” the contents of which are incorporated herein by reference.

### BACKGROUND OF THE INVENTION

1. Field of the Invention

The present invention relates to Integrity Protection in a wireless communications systems, and more particularly, to a method of initializing Integrity Protection in a communications device in the wireless communications system.

2. Description of the Prior Art

The third generation (3G) mobile communications system has adopted a Wideband Code Division Multiple Access (WCDMA) wireless air interface access method for a cellular network. WCDMA can provide high frequency spectrum utilization, universal coverage, and high quality, high speed multimedia data transmission. The WCDMA method also meets all kinds of QoS requirements simultaneously, providing diverse flexible two-way transmission services and better communication quality to reduce transmission interruption rates.

For the universal mobile telecommunications system (UMTS), the 3G communications system comprises User Equipment (UE), the UMTS Terrestrial Radio Access Network (UTRAN), and the Core Network (CN). Communications protocols utilized include Access Stratum (AS) and Non-Access Stratum (NAS). AS comprises various sub-layers for different functions, including Radio Resource Control (RRC), Radio Link Control (RLC), Media Access Control (MAC), Packet Data Convergence Protocol (PDCP), and Broadcast/Multicast Control (BMC). The sub-layers mentioned, and their operating principles, are well known in the art, and detailed description thereof is omitted. RRC is a Layer 3 communications protocol, and is the core of the AS communications protocol. All radio resource information exchange, radio resource configuration control, QoS control, channel transmission format configuration control, packet segmentation/concatenation processing and control, and NAS protocol transmission processing is performed by the RRC layer.

The RRC layer is located in the Radio Network Controller (RNC) of the UTRAN and the UE, and is primarily used to manage and maintain packet switching and sequencing of a Uu Interface. The RRC layer performs radio resource control in the following manner. After the RRC of the UE obtains various measurement results from the MAC and the Physical Layer, the RRC generates a Measurement Report from the various measurement results. After processing by the RLC, the MAC, and the Physical Layer, the Measurement Report is sent to the RRC of a network end, e.g. UTRAN. After a Radio Resource Assignment message sent from the RRC of the network end is received, the RRC of the user end can perform lower layer control and setting based on a result of resolving the message, e.g. setting the operation mode, packet length, and encryption method of the RLC layer, setting the channel multiplexing mapping method and channel transmission format of the MAC, and setting the operating frequency, spreading code, transmission power, synchronization method, and measurement items of the Physical Layer.

Between the user end and the network end, the RRC layer uses RRC Messages, also known as signaling, to exchange information. RRC Messages are formed from many Information Elements (IE) used for embedding necessary information for setting, changing, or releasing protocol entities of Layer 2 (RLC, MAC) and Layer 1 (Physical Layer), thereby establishing, adjusting, or canceling information exchange channels to perform data packet transportation. Through RRC Messages, the RRC layer can embed control signals needed by an upper layer in the RRC Message, which can be sent between the NAS of the user end and the CN through the radio interface to complete the required procedures.

From the standpoint of the RRC, all logical data communication exchange channels, be they for providing data transmission exchange to the user or for providing RRC layer control signal transmission exchange, are defined in the context of a Radio Bearer (RB). In the user end, the RB comprises one unidirectional or a pair of uplink/downlink logic data transmission exchange channels. In the network end, the RB comprises one unidirectional or a pair of uplink/downlink logic data transmission exchange channels.

According to different usage goals, the RB can be divided into different categories, wherein the RB specifically used for transmitting RRC signals is generally called a Signaling Radio Bearer (SRB), which includes:

1. SRB0: Uplink (UL) uses Transparent Mode (TM) transmission, Downlink (DL) uses Unacknowledged Mode (UM) transmission, and data is exchanged through a Common Control Channel.

2. SRB1: The UL and DL both use UM transmission, and data is exchanged through a Dedicated Control Channel.

3. SRB2: The UL and DL both use Acknowledged Mode (AM) transmission, and data is exchanged through a Dedicated Control Channel.

4. SRB3: The same as SRB2, but the content of the data transmitted is specifically for the upper layer of the RRC protocolwith higher priority.

5. SRB4: The same as SRB3, but the data transmitted is for the upper layer of the RRC protocol with lower priority.

Through use of the SRBs, the RRC layers of the user end and the network end can exchange RRC messages, as a basis for radio resource settings, and for completing various RRC control processes. In the prior art, RRC procedures can be categorized by function as RRC Connection Management Procedures, RB Control Procedures, RRC Connection Mobility Procedures, and Measurement Procedures. RRC Connection Management Procedures are primarily for establishing, maintaining, and managing the signaling link between the user end and the network end, and include a Security Mode Control Procedure, which is used for performing encryption and integrity protection actions to secure data transmission.

The primary goal of the Security Mode Control Procedure is turning on, or modifying configuration of, encryption of SRBs for control plane and RBs for user plane, and can also be used to turn on, or modify configuration of, an Integrity Protection procedure for the SRBs. The concept of Integrity Protection is similar to an electronic signature. Every time the user end or the network end transmits signaling message, the user end or the network end will add the electronic signature, whose content is different for each signaling message. A legal user end or network end can use an Integrity Key to authenticate the accuracy of the electronic signature, and thereby decide whether or not to accept the received signaling message and perform the actions indicated in the signaling message.

The Integrity Protection procedure is primarily used for protecting all SRBs, to prevent fake signaling from unrelated parties from compromising security, and calculates information required for providing Integrity Protection, such as the electronic signature mentioned above, based on a UMTS Integrity Algorithm (UIA). The UIA uses the following five parameters in an f9 algorithm to calculate a Message Authentication Code for data Integrity (MAC-I). The five parameters are defined and described in detail in the RRC Communications Protocol Standard (3GPP TS 25.331 V.6.7.0) set forth by the 3^{rd} Generation Partnership Project (3GPP). Briefly, the five parameters are:

1. Integrity Key (IK): Generated by the user end or the network end, and 128 bits long.

2. Integrity Sequence Number (COUNT-I): Each SRB includes an uplink COUNT-I and a downlink COUNT-I. Each COUNT-I is formed of a 28-bit RRC Hyper Frame Number (RRC-HFN) and a 4-bit RRC Sequence Number (SN), for a total of 32 bits.

3. Network-Side Nonce (FRESH): Generated by the network end, with a length of 32 bits.

4. Direction Identifier (DIRECTION): Utilized for indicating uplink or downlink transmission, with a length of 1 bit.

5. Signaling Message (MESSAGE).

The UTMS Integrity Algorithm can be expressed as:
MAC-I=f9(IK, COUNT-I, FRESH, DIRECTION, MESSAGE).

Operation of the Integrity Protection (IP) procedure starts with the user end and the network end each storing or maintaining the same RRC-HFN and FRESH values. Then, the network end calculates a message access code for data integrity (MAC-I) through the UIA based on the content and sequence number RRC-SN of an RRC message of a Security Mode Command comprising Integrity Protection parameter settings. The network end sends the Security Mode Command RRC message and the MAC-I (called the IP Command or the IP Command message hereinafter) through an SRB to the user end. After the user end receives the IP command, the user end calculates a new MAC-I through the UIA, and compares the new MAC-I with the MAC-I received from the network end. If they are the same, Downlink IP is activated, and another MAC-I is calculated based on content of a Security Mode Complete RRC message and the Uplink RRC-SN. The Security Mode Complete RRC message and the MAC-I (called the IP Complete message hereinafter) are sent back to the network end. After the network end receives the IP Complete message, another MAC-I is calculated from the Uplink RRC -SN, and compared with the MAC-I received. If they are the same, Uplink IP is activated.

Simply speaking, in the IP procedure, the user end calculates a new MAC-I based on the IP Command outputted by the network end, and compares the new MAC-I to the MAC-I (in the IP Command) outputted by the network end. If they are the same, Downlink IP is activated in the user end, and an IP Complete message is sent back to the network end. Then, the network end calculates a MAC-I based on the IP Complete message received from the user end, and compares the MAC-I with the MAC-I (in the IP Complete message) received from the user end. If they are the same, Uplink IP is activated in the network end.

Generally speaking, transmission of the IP Command and IP Complete messages is completed through SRB2. Of course, other SRBs could be utilized as well. For the sake of simplicity, in the following explanation, it is assumed that the IP Command and IP Complete messages are transmitted through SRB2. In addition, the IP Command message comprises two modes of operation, including Start Integrity Protection and Modify Integrity Protection. As implied by their names, Start Integrity Protection utilizes the IP Command message to activate Integrity Protection when the SRB has not yet activated IP; and, Modify Integrity Protection changes IP configuration after the SRB has activated Integrity Protection.

According to the RRC Communications Protocol Standard 3GPP TS 25.331 V6.7.0 mentioned above, when the user end receives the IP Command, the user end will immediately begin using the new Integrity Protection settings on the Uplink SRB2. If the IP Command is in Modify Integrity Protection mode, the user end will prohibit transmission of all messages in SRBs other than SRB2 that have sequence numbers greater than the activation time. Only after the user end receives acknowledgement from the network end that the network end has successfully received the IP Complete message does the user end remove the transmission restriction. On the other hand, if the IP Command message is in Start Integrity Protection mode, the user end will activate Integrity Protection on the Uplink SRB2, and respond with the IP Complete message. And, the user end will not prohibit message transmission on the SRBs other than SRB2. In this situation, all SRBs can activate Integrity Protection for transmitting messages. Thus, it is possible for the network end to receive a message comprising Integrity Protection through an SRB other than SRB2, e.g. SRB3, before receiving the IP Complete message through SRB2. Because the network end has not yet received the IP Complete message, the network end will mistakenly determine that the message comprising Integrity Protection is ineffective, and will discard the message.

In summary, in Start Integrity Protection mode, the prior art does not prohibit transmission of messages on the SRBs other than SRB2, such that other messages transmitted on the other SRBs reach the network end before the IP Complete message, causing the network end to determine mistakenly that the message comprising Integrity Protection is ineffective, and discard the message, which wastes system resources.

### SUMMARY OF THE INVENTION

According to the present invention, a method of starting Integrity Protection in a receiving end of a radio communications system comprises receiving a first Radio Resource Control (RRC) message for starting Integrity Protection, utilizing a first Signaling Radio Bearer (SRB) to output a second RRC message to a network end of the radio communications system for indicating completion of starting Integrity Protection, and prohibiting a second SRB from transmitting a third RRC message before receiving a confirmation message from the network end acknowledging successful receipt of the second RRC message.

According to the present invention, a communications device utilized in a radio communications system for preventing a third Radio Resource Control (RRC) message from being discarded unnecessarily during activation of Integrity Protection comprises a control circuit for realizing functions of the communications device, a central processing unit coupled to the control circuit for executing a program code to operate the control circuit, and a memory coupled to the central processing unit for storing the program code. The program code comprises receiving a first Radio Resource Control (RRC) message for starting Integrity Protection, utilizing a first Signaling Radio Bearer (SRB) to output a second RRC message to a network end of the radio communications system for indicating completion of starting Integrity Protection, and prohibiting a second SRB from transmitting the third RRC message before receiving a confirmation message from the network end acknowledging successful receipt of the second RRC message.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of a communications device.

FIG. 2 is a diagram of program code in FIG. 1.

FIG. 3 is a flow chart of the present invention method.

### DETAILED DESCRIPTION

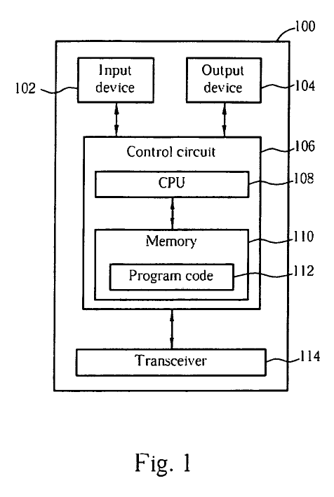

Please refer to FIG. 1, which is a functional block diagram of a communications device 100. For the sake of brevity, FIG. 1 only shows an input device 102, an output device 104, a control circuit 106, a central processing unit (CPU) 108, a memory 110, a program code 112, and a transceiver 114 of the communications device 100. In the communications device 100, the control circuit 106 executes the program code 112 in the memory 110 through the CPU 108, thereby controlling an operation of the communications device 100. The communications device 100 can receive signals input by a user through the input device 102, such as a keyboard, and can output images and sounds through the output device 104, such as a monitor or speakers. The transceiver 114 is used to receive and transmit wireless signals, delivering received signals to the control circuit 106, and outputting signals generated by the control circuit 106 wirelessly. From a perspective of a communications protocol framework, the transceiver 114 can be seen as a portion of Layer 1, and the control circuit 106 can be utilized to realize functions of Layer 2 and Layer 3.

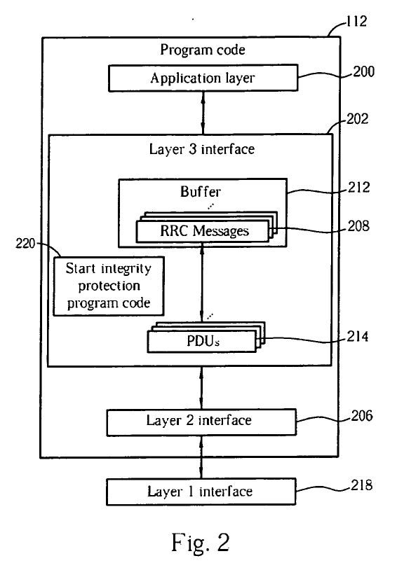

Please continue to refer to FIG. 2. FIG. 2 is a diagram of the program code 112 shown in FIG. 1. The program code 112 comprises an application layer 200, a Layer 3 interface 202, and a Layer 2 interface 206, and is coupled to a Layer 1 interface 218. The Layer 3 interface 202 comprises a buffer for storing an RRC message 208, and for forming an RRC PDU 214 according to the RRC message 208. The application layer 200 provides control signals required by necessary procedures, which can be outputted by attaching the control signals to RRC PDUs 214 for setting, modifying, or releasing the Layer 2 interface 206 and the Layer 1 interface 218, to establish, modify, or cancel data exchange channels.

To prevent a loss of security due to false signaling from unrelated parties and protect message transmission on the SRBs, the Layer 3 interface 202 can activate the Integrity Protection procedure. In this situation, the present invention provides Start Integrity Protection program code 220.

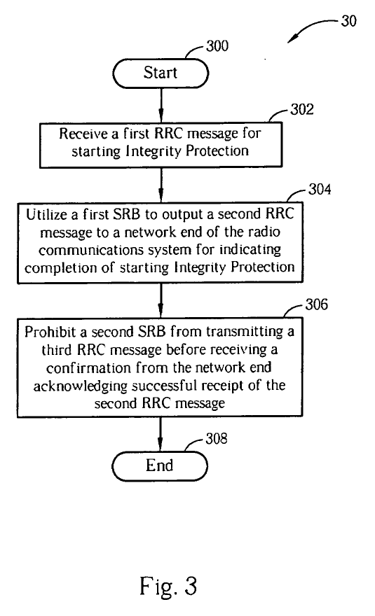

Please refer to FIG. 3, which is a flowchart diagram of a process 30 according to the present invention. The process 30 is used to start Integrity Protection in a receiver of the communications system, and can be seen as the Start Integrity Protection program code 220. The process 30 comprises the following steps:

Step 300: Start.

Step 302: Receive a first RRC message, e.g. IP Command, used for starting Integrity Protection.

Step 304: Output a second RRC message, e.g. IP Complete, used for indicating completion of starting Integrity Protection to a network end of the communications system through a first SRB.

Step 306: Prohibit transmission of a third RRC message on a second SRB before receiving a confirmation message acknowledging that the network end has successfully received the second RRC message.

Step 308: End.

Thus, according to the process 30, when the receiver, e.g. the user end, receives the IP Command message outputted by the network end, if the IP Command message indicates the Start Integrity Protection mode, the user end will immediately start Integrity Protection check on the IP Command message, and transmit an IP Complete message on SRB2, i.e. the first SRB mentioned above. Before receiving the confirmation message acknowledging that the network end has already successfully received the IP Complete message, the user end will not transmit RRC messages with Integrity Protection on other SRBs. In other words, when the IP Command message is in Start Integrity Protection mode, the user end prohibits message transmission on SRBs other than SRB2. In this state, messages can only be transmitted on SRB2, which is used for sending back the IP Complete message. Thus, after the network end receives the IP Complete message over SRB2, the network end can start Integrity Protection for uplink RRC messages. In this way, when the network end receives messages outputted from other SRBs, the network end can use the Integrity Protection procedure to perform authentication.

Simply speaking, in the prior art, when the user end receives the Start Integrity Protection IP Command, the user end immediately applies the indicated Integrity Protection configuration to all messages to be transmitted. If the network end receives other messages using Integrity Protection before receiving the IP Complete message outputted by the user end, the network end will mistake the other messages as ineffective, and discard them. In contrast, in the present invention, while the network end has not acknowledged receipt of the IP Complete message outputted by the user end, the user end will not output any other messages using Integrity Protection. The user end will only output other messages that use Integrity Protection after the network end successfully receives the IP Complete message outputted by the user end and sends acknowledgement to the user end. Thus, the network end can accurately receive the messages using Integrity Protection. In this way, the messages can easily pass authentication at the network end, thereby reducing system resource waste.

In the present invention, the user end will not transmit messages using Integrity Protection before the network end successfully receives the IP Complete message and sends acknowledgement to the user end. Based on the RRC Communications Protocol Standard 3GPP TS 25.331 V6.7.0, messages using Integrity Protection all have a sequence number greater than or equal to an Activation Time. The Activation Time is utilized to start applying Integrity Protection. In other words, the user end will not transmit messages having a sequence number greater than the Activation Time before receiving acknowledgement that the network end successfully received the IP Complete message.

Summarizing the above, when starting Integrity Protection, the user end will not transmit any messages using Integrity Protection over SRBs other than SRB2 before the network end successfully receives the IP Complete message outputted by the user end through SRB2 and sends acknowledgement to the user end. Thus, the network end will not mistake the messages as ineffective and discard them, thereby preventing system resource waste. In other words, the present invention can prevent messages from being discarded unnecessarily, and thereby increase efficiency of system resource use, greatly improving upon the weaknesses of the prior art.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of starting Integrity Protection in a receiving end of a radio communications system comprising:
receiving a first Radio Resource Control (RRC) message for starting Integrity Protection;
utilizing a first Signaling Radio Bearer (SRB) to output a second RRC message to a network end of the radio communications system for indicating completion of starting Integrity Protection; and
prohibiting a second SRB from transmitting a third RRC message before receiving a confirmation message from the network end acknowledging successful receipt of the second RRC message.

2. A communications device utilized in a radio communications system for preventing a third Radio Resource Control (RRC) message from being discarded unnecessarily during activation of Integrity Protection, the communications device comprising:
a control circuit for realizing functions of the communications device;
a central processing unit coupled to the control circuit for executing a program code to operate the control circuit; and
a memory coupled to the central processing unit for storing the program code;
wherein the program code comprises: receiving a first Radio Resource Control (RRC) message for starting Integrity Protection;
utilizing a first Signaling Radio Bearer (SRB) to output a second RRC message to a network end of the radio communications system for indicating completion of starting Integrity Protection; and
prohibiting a second SRB from transmitting the third RRC message before receiving a confirmation message from the network end acknowledging successful receipt of the second RRC message.

3. The method of claim 1 and the communications device of claim 2, wherein the first SRB operates in Acknowledged Mode.

4. The method of claim 1 and the communications device of claim 2, wherein receiving the first Radio Resource Control (RRC) message for starting Integrity Protection comprises adopting an Integrity Protection configuration indicated by the first RRC message.

5. The method of claim 1 and the communications device of claim 2, wherein the third RRC message adopts an Integrity Protection Configuration indicated by the first RRC message.

6. The method of claim 1 and the communications device of claim 2, wherein a sequence number of the third RRC message is greater than or equal to an activation time utilized for activating Integrity Protection.

7. The method of claim 1 and the communications device of claim 2 further comprising permitting the second SRB to perform transmission when a confirmation message from the network end acknowledging successful receipt of the second RRC message is received.

8. The communications device of claim 2 being a radio mobile communications device.
